(19) United States
(12) Patent Application Publication
(10) Pub. No.: US 2015/0201399 A1
(43) Pub. Date: Jul. 16, 2015

(54) PAGING COMMUNICATION SYSTEM PROVIDING FUNCTIONS OF TWO-WAY COMMUNICATION AND CONTROL FOR ONE-WAY PAGER GROUPS

(71) Applicant: Unication Co., Ltd., New Taipei City (TW)

(72) Inventor: SHIH-TSENG YEH, New Taipei City (TW)

(73) Assignee: Unication Co., Ltd., New Taipei City (TW)

(21) Appl. No.: 14/155,347

(22) Filed: Jan. 14, 2014

(51) Int. Cl. H04W 68/02; H04W 4/12

(52) U.S. Cl. CPC H04W 68/02; H04W 4/12

(57) ABSTRACT

A paging communication system providing functions of two-way communication and control (supervisory) for one-way pager groups, comprises a monitoring server having functions of monitoring pager status/dispatch/response/tracking for control and two-way communication between a controller (managers)/commander of an emergency rescue group and pagers of all group members; the group of using pagers can access to the monitoring server for registration via Internet; after linking to the monitoring server, the controller of the pager group and all group members can transmit messages, such as dispatch messages and Ack messages, to the monitoring server in process of classification/statistics and storage in a database, and then the controller can access to the database via Internet to search and look at each message, and also each group member can retrieve the paging messages from the monitoring server via GSM/GPRS system; the group which has logged in the monitoring server has the ability of two-way communication.

### BACKGROUND OF THE INVENTION

1. Field of the Invention

The present invention relates to a paging communication system for providing functions of two-way communication and control (management of the pager status and dispatch) for one-way pager groups, especially to a monitoring server provided for emergency rescue groups to perform to the two-way communication between the transmitter (Console) operated by a controller/commander and pagers carried by the group members in a traditional one-way communication system; the monitoring server has functions of collection, classification, statistics and inquiry of data, wherein the data comprises dispatch messages sent from the controller/commander (dispatch center) and acknowledgement (Ack) messages or other requests sent from group members, and provided for pager groups with joined the monitoring server in order to enhance the ability of command, management and communication.

2. The Related Art

Generally, emergency rescue groups, such as the police, medical groups, military or disaster-relief teams, usually take pagers as means of communication for dispatch and emergency notification. Referring to FIG. 1, the main device of each group at least comprises a transmitter 10 utilized by a controller for transmission paging/RF message, and a voice/text pager 20 carried by each group member, and further comprises a stationary/mobile repeater (not shown) for extending communication range of a group; however, the traditional pager can only receive messages as a one-way communication equipment but does not perform the transmission because of lack of transmission circuit.

Next, the transmitter 10 of the paging communication system further comprises a stationary/mobile Console usually having a computer 30. Anyhow, the transmitter 10 considered as a transmission equipment dedicated to single pager group does not have functions of data collection, classification and statistics, does not enable the group members to connect to the computer 30 or databases of the Console through the pager 20 for retrieving or requiring for messages, and does not allow the messages sent from pager back to the Console. Consequently, the group members are not capable of making connection with the controller/commander in the manner of two-way communication; furthermore, for general small-scale groups of the pager 20 users, the purchase and maintenance costs of the traditional Console equipment are correspondingly too high for small-scale groups to afford; those obstacles described above may make pager groups fail to carry out the require of commanding and managing effectively.

In light of the problem out of the above traditional one-way paging communication system that can only perform one-way communication with no functions of the collection, classification, statistics of data; therefore, it is necessary to provide a novel paging communication system for the one-way paging communication system in order for the traditional one-way paging communication system to utilize a monitoring server that provides function of control and two-way communication between the controller and the group member.

### SUMMARY OF THE INVENTION

Accordingly, an object of the present invention is to provide a monitoring server suitable for one-way paging communication system by which pager groups dedicated to emergency rescue or other closed groups can register on the monitoring server via Internet or Web to join the monitoring server for performing to the two-way communication.

Another object of the present invention is to provide a monitoring server suitable for one-way paging communication system by which several groups can simultaneously make use of the monitoring server to reduce the cost of construction and maintenance of the monitoring server for small-scale pager groups.

To achieve the above objects, a paging communication system providing functions of two-way communication and control for one-way pager groups at least comprises a transmitter operated by a controller/commander of a paging group, and comprises voice/text pagers carried by each group member, and further comprises a monitoring server.

In accordance with the present invention, the monitoring server at least comprises a multiplexing processor, a database and an Internet communication module, wherein the multiplexing processor is respectively coupled to the database and the Internet communication module; the multiplexing processor is capable of accepting online registration from any Internet-connected pager groups through the Internet communication module for the establishment of linkage and capable of receiving messages or data from the Internet communication module to perform classification/statistics in accordance with an identification code (ID) of each group or/and an identification code of each group member, and thereafter to perform storage in the database.

In accordance with the present invention, the monitoring server may further link with a GSM/GPRS system through Internet communication module for receiving/transmitting short messages or other messages (including operating commands) from/to the pagers of each group via the GSM/GPRS system.

In accordance with the present invention, the transmitter (Console) is further capable of connecting to a computer, utilized for linking the monitoring server via Internet and transmitting/receiving messages (or commands) from/to the monitoring server; the transmitter can also access to the database of the monitoring server via Internet for inquiring or tracking all of the status and messages replied from the pagers of group members.

In accordance with the present invention, the several pagers further comprise a GSM communication module, utilized for linking the monitoring server via GSM/GPRS system and transmitting/receiving Ack or other messages (or command) in form of SMS or GPRS from/to the monitoring server, and the pager can access to the database via the GSM/GPRS system for retrieval of the message that has sent from the transmitter, or can require the monitoring server for retransmitting the message.

In accordance with the present invention, in practice, any pager group of one-way paging communication system can register on the monitoring server via Internet and after linking to the monitoring server, the controller (or the commander) and every member in the group can transmit messages (including the dispatch messages transmitted from the controller and Ack messages or command transmitted from the group members) to the monitoring server for classification/statistics and storage in the database in accordance with the identification code of group or/and each member obtained from the registration; and the monitoring server thereby allows all group members to access to the database via Internet or the GSM/GPRS system for browse and acquisition of the needed message based on identification code of the group or/and individual registration, so as to make the group have the ability of two-way communication.

### BRIEF DESCRIPTION OF THE DRAWINGS

FIG. 1 is a schematic view showing a one-way paging communication system for a traditional pager group;

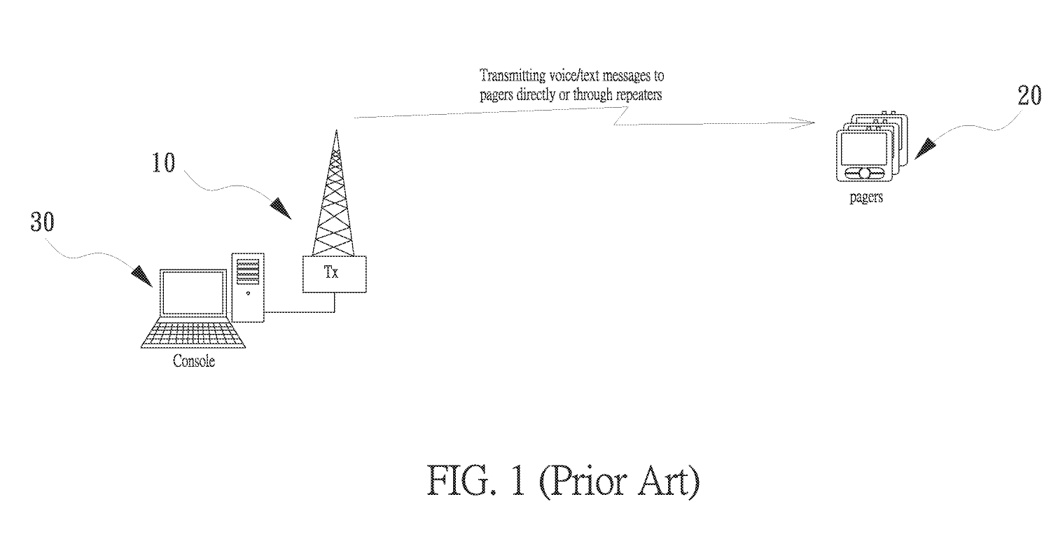

FIG. 2 is a schematic view showing a system in an embodiment of the present invention;

FIG. 3 is a circuit block diagram of a monitoring server and a schematic view showing a system linkage of the present invention; and

FIG. 4 is a schematic view showing a system in another embodiment of the present invention.

### DESCRIPTION OF THE PREFERRED EMBODIMENTS

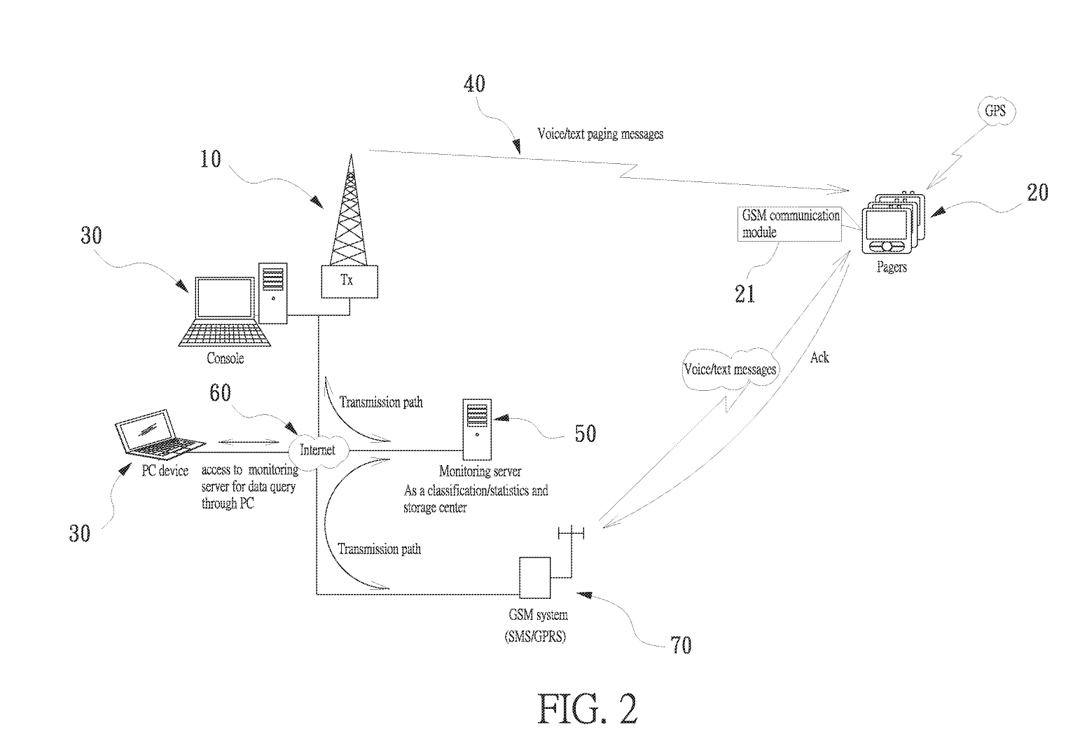

Referring to FIG. 2, a paging communication system providing functions of two-way communication and control (supervisory) for one-way pager groups at least comprises a transmitter 10 utilized by a controller or a commander of a paging group, and voice/text pagers 20 carried by each group member, wherein the transmitter 10 transmits dispatch messages or commands via a RF channel 40 (Radio Frequency channel) to one or more pagers 20; the paging communication system further comprises a monitoring server 50 having functions of data collection, classification, statistics and inquiry.

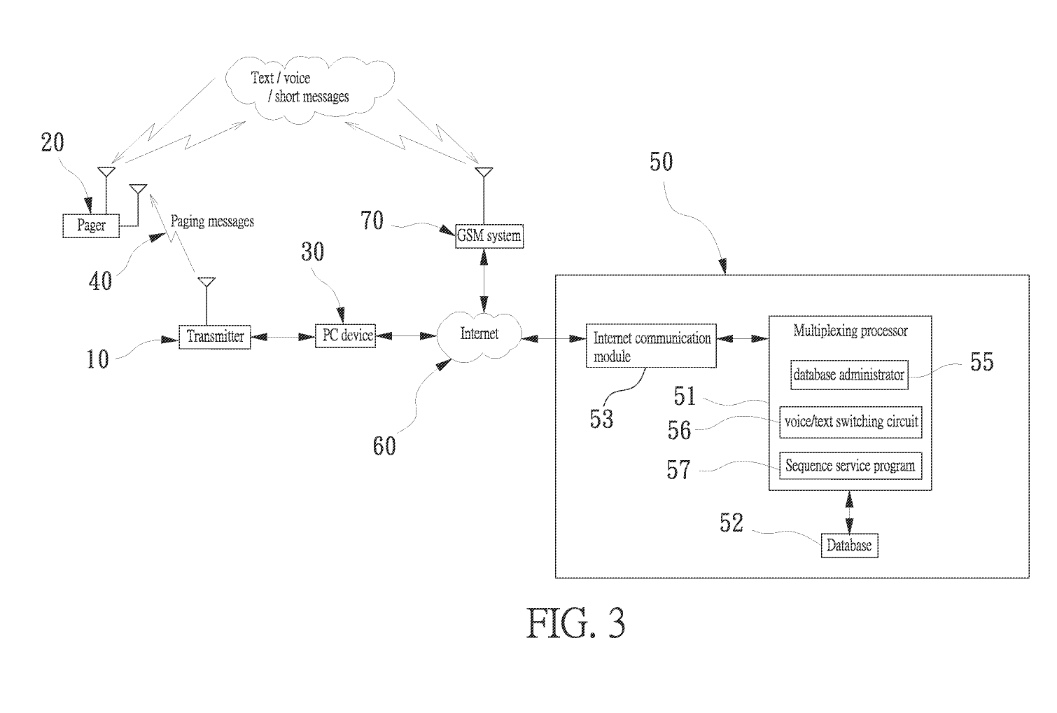

The monitoring server 50, shown in FIG. 3, at least comprises a multiplexing processor 51, a database 52 and an Internet communication module 53, wherein the multiplexing processor 51 is respectively coupled to the database 52 and the Internet communication module 53; the multiplexing processor 51 is capable of accepting online registration from any Internet-connected pager groups through the Internet communication module 53 for the establishment of linkage and capable of receiving messages or data from the Internet communication module 53 to perform classification/statistics in accordance with an identification code (ID) of each group or/and an identification code of each group member, and thereafter to perform storage in the database 52.

The monitoring server 50 may further link with a GSM/GPRS system 70 through Internet communication module 53 for receiving/transmitting short messages or other messages from/to the pagers 20 of each group via the GSM/GPRS system 70, and for forwarding the messages from the transmitter 10 to a certain pager 20 via the GSM/GPRS system 70.

The transmitter 10 is further capable of connecting to a computer 30 as a Console or a dispatch center utilized by the controller or commander of the group; the computer 30 is utilized for linking the monitoring server 50 via Internet 60 and transmitting/receiving messages or commands from/to the monitoring server 50; the transmitter 10 can also access to the database 52 of the monitoring server 50 via Internet 60 for inquiring or tracking all of the messages replied from pagers of group members.

The several pagers 20 further comprise a GSM communication module 21, utilized for linking the monitoring server 50 via GSM/GPRS system 70 and transmitting/receiving Ack messages or commands in form of SMS or GPRS from/to the monitoring server 50, and the pager 20 can access to the database 52 for retrieval of the stored message via the GSM/GPRS system 70 and Internet 60, or the pager 20 can require the monitoring server 50 for retransmitting or forwarding the message at some point in time sent from the transmitter 10, for example, the content of the message sent from the pager 20 may includes positioning information or some status such as Shutdown, On Break, Out of Range, Standing By, Assignment Accept, Assignment Refusal or Must Delay for One Hour and so on forth.

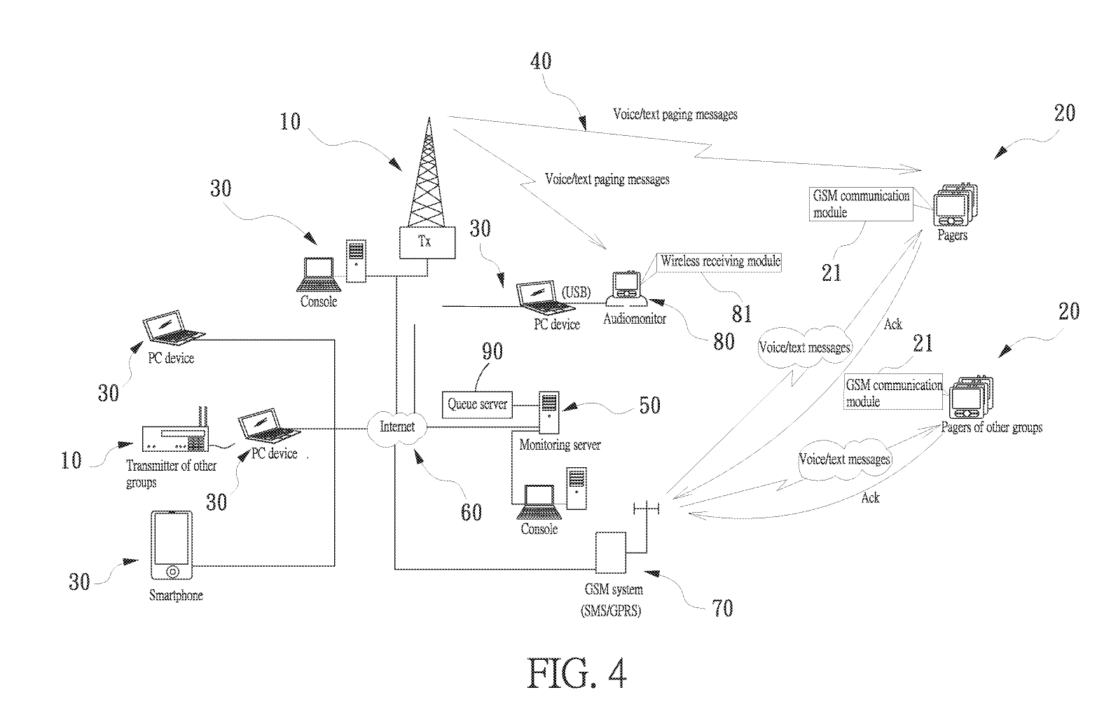

As described above, please further referring to FIG. 2 and FIG. 4, when using one-way paging communication system that fails to carry out two-way communication between a transmitter (controller/commander) and group members, the monitoring server 50 can provide the access to Internet for the pager group to register for joining the service system of the monitoring server 50 in order for the transmitter 10 of each pager group able to establish the linkage to the monitoring server 50 via Internet 60 at the same time, and in order for the pager 20 of each pager group able to establish the linkage to the monitoring server 50 via the GSM/GPRS system 70 for ease of taking the monitoring server 50 as a bridge for two-way communication between the controller or the commander and the group members in each pager group.

As described above, during the registration of pager group to the monitoring server 50, the controller or the commander of any pager group needs to work on the computer 30 and transmits the identification code and the name of the pager group and the identification code and the name of all group members and so on forth via Internet 60 to the monitoring server 50 that thereafter sets files up for management, so as to completing the registration procedure to become one of the monitoring server 50 users after receiving an Ack (confirmation) and completing the linkage.

The monitoring server 50 can simultaneously receive the messages from transmitters 10 of several groups or from pagers 20 of group members, including dispatch messages or Ack messages, and can perform classification and statistics for the received messages in accordance with the identification code of the pager group and the group members thereof and then can store in the database 52; and further, the monitoring server 50 can initiate a data management program 55 that stores the received messages or information in the form of multiple pages in the database 52 as an individual file according to the identification code of the pager group or/and the category of information, so that the controller (including the commander or other group members) can access through the computer 30 or any other computers for inquiry in accordance with the registered identification code, e.g. the computer 30 can be personal computer, laptop, cell phone, panel and so on forth.

The monitoring server 50 further comprising a voice/text converting circuit 56 or software can automatically convert the received voice message to the text message in response to the request of the message or the commands sent from the transmitter 10 or the pager 20, and thereafter store in the database 52; and further, in response to the request of the message or the commands sent from the transmitter 10 or the pager 20, the monitoring server 50 can automatically forward the text message or the commands of converted to a certain transmitter 10 or a certain pager 20.

The message sent from the transmitter 10 of each group to the monitoring server 50 at least comprises identification code of group, message sending time, dispatch(text/voice) message or/and control commands; and the message sent from the pager of the group members comprises identification code of group, personal identification code and comprises at least one of the message sending time, equipment status, status of reception, GPS location information or control commands execution status in order for the classification and embedding into corresponding pages; and the monitoring server 50 allows any Internet-connected computer to access for inquiry.

Further referring to FIG. 4, the system further comprises an audiomonitor 80, and the audiomonitor 80 comprises a wireless receiving module 81 utilized for monitoring through the RF channel 40 and for reception of messages, e.g. dispatch messages or operating commands for changing the status of pager, from the transmitter 10 and utilized for forwarding the monitoring server 50 through the linkage of the Internet/Web system and the monitoring server 50 that thereafter performs classification/statistics and stores in accordance with the identification code involved in the messages so as to achieve said objects and effects of the present invention.

In this embodiment, the audiomonitor 80 described above includes a pager and a base that erects the pager, e.g. a charging cradle, and the base is connected with the computer 30 that transmits the received message from the audiomonitor 80 via Internet 60 to the monitoring server 50 as a backup so as to retransmit or forward the stored message to the pager 20 which needs the stored message in the future.

As above, the monitoring server 50 can further make a linkage with a queue server 90 as shown in FIG. 4, and the queue server 90 at least links to an another transmitter utilized for transmitting messages to pagers through the RF channel 40; besides, the queue server 90 can be a built-in or external device of the monitoring server 50. When several messages sent from one or more groups need to be sent simultaneously, the queue server 90 can obtain the messages or the commands that is going to be transmit from the monitoring server 50, and then transmit the message needed to be sent to each pager through the another transmitter via the RF channel 40 in order of time that the monitoring server 50 receives the messages.

It is understood that the invention may be embodied in other forms within the scope of the claims. Thus the present examples and embodiments are to be considered in all respects as illustrative, and not restrictive, of the invention defined by the claims.

What is claimed is:

1. A paging communication system providing functions of two-way communication and control for one-way pager groups, the system at least comprising:
a transmitter for transmitting dispatch messages or commands via a Radio Frequency (RF) channel to one or more pagers of the pager groups; and
a monitoring server having functions for data collection, classification, statistics and inquiry;
wherein the monitoring server at least comprises a multiplexing processor, a database and an Internet communication module, wherein the multiplexing processor is respectively coupled to the database and the Internet communication module; the multiplexing processor is capable of accepting online registration from any Internet-connected pager groups through the Internet communication module for the establishment of linkage, and capable of receiving messages or data from the Internet communication module to perform classification/statistics in accordance with an identification code of each registered group or/and an identification code of each registered group member, and thereafter to perform storage in the database;
wherein the monitoring server further links with a Global System for Mobile Communications/General Packet Radio Service (GSM/GPRS) system through the Internet communication module for receiving/transmitting Acknowledgement (Ack) or other messages from each pager of each group via the GSM/GPRS system, and for forwarding the messages that has been sent from the transmitter to a certain pager via the GSM/GPRS system;
wherein the transmitter is further capable of linking to a computer utilized for linking the monitoring server via Internet and for transmitting/receiving messages or commands from/to the monitoring server; the transmitter is also capable of accessing to the database of the monitoring server via Internet for inquiring or tracking all of the messages replied from the pagers of the group; and
wherein the pagers further comprise a GSM communication module, utilized for linking the monitoring server via the GSM/GPRS system and transmitting/receiving Ack or other messages or commands in form of Short Message Service (SMS) or GPRS from/to the monitoring server, and the pager is capable of accessing to the database via the GSM/GPRS system for retrieval of the message that has sent from the transmitter, or capable of requiring the monitoring server for retransmitting the message.

2. The paging communication system of claim 1, wherein the monitoring server comprises a data management program, utilized for showing the messages or information that has been completed the process of classification/statistics and then stored in the database on the computer screen of inquirers in the form of multiple pages in accordance with the identification code of group or category of information.

3. The paging communication system of claim 1, wherein the messages sent from the transmitter of any group to the monitoring server at least comprises an identification code of group, a message sending time, a dispatch message or/and a control commands.

4. The paging communication system of claim 1, wherein the messages sent from the pager of any group member in the form of Ack to the monitoring server comprises an identification code of group, a personal identification code and comprises at least one of the a message sending time, an equipment status, a status of reception, a GPS location information or a control command execution status.

5. The paging communication system of claim 1, wherein the monitoring server is further capable of automatically forwarding messages or commands to the transmitter or the pagers of group members in response to the request of the message or the commands from a transmitter or pager.

6. The paging communication system of claim 1, wherein the monitoring server is further capable of automatically converting received voice messages from the transmitter into text messages in accordance with program settings or request of external device, and then storing in the database in accordance with the identification code of group or/and group members.

7. The paging communication system of claim 1, the system further comprises an audiomonitor, the audiomonitor includes a wireless receiving module utilized for audiomonitoring and receiving messages sent from the transmitter via the RF channel and thereafter forwarding the messages to the monitoring server through the linkage of the Internet system and the monitoring server that finally performs classification/statistics and storage in accordance with the identification code involved in the messages.

8. The paging communication system of claim 1, the monitoring server is further capable of making a linkage with a queue server, and the queue server at least links to an another transmitter utilized for transmitting messages via the RF channel; and when several messages from one or more groups need to be sent simultaneously, the queue server is capable of obtaining the messages needed to be sent from the monitoring server, and then transmitting the messages needed to be sent to each pager through the another transmitter in order of time that the monitoring server receives the messages.
